(19) United States
(12) Patent Application Publication
(10) Pub. No.: US 2008/0273570 A1
(43) Pub. Date: Nov. 6, 2008

(54) Optically Pumped Waveguide Laser With a Tapered Waveguide Section

(75) Inventor: Holger Moench, Vaals (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,039

(22) PCT Filed: Nov. 23, 2006
(86) PCT No.: PCT/IB06/54400

§ 371 Date: Jun. 4, 2008

(30) Foreign Application Priority Data
Dec. 9, 2005 (EP) 05111905.5

(51) Int. Cl. H01S 3/091

(52) U.S. Cl. 372/71; 372/70

(57) ABSTRACT

The present invention relates to an optically pumped waveguide laser (2) comprising a waveguide with an optical propagation layer (3, 4) and two resonator mirrors (6, 7). The propagation layer (3, 4) consists of a gain medium at least along a section of said waveguide, said gain medium allowing up-conversion or down-conversion of incident pump light. One of the resonator mirrors is at least partially transparent to the pump light so as to allow end-pumping of the waveguide laser through a first end face (8) of the waveguide. The propagation layer (3, 4) has a geometrical width which is reduced in a first section of the waveguide, starting from the first end face (8) towards a second end face (9), thereby increasing an energy density of the incident pump light when propagating in the first section towards the second end face (9). In the proposed waveguide laser, the pump light is concentrated in the first section of the waveguide, resulting in a higher energy density which lowers the laser threshold and increases the efficiency. The propagation layer (3, 4) is surrounded by a cladding material (5) having a lower refractive index than the propagation layer (3, 4).

The present invention relates to an optically pumped waveguide laser comprising a waveguide with an optical propagation layer and two resonator mirrors for forming a resonator cavity, wherein said propagation layer consists of a gain medium at least along one section of the waveguide, said gain medium allowing up-conversion or down-conversion of incident pump light, and wherein said first resonator mirror is at least partially transparent to the pump light so as to allow end pumping of the waveguide laser through a first end face of the waveguide. The present invention is in particular useful for up-converting or down-converting light emitted from a laser diode or a laser diode bar in the infrared (IR) or deep blue wavelength range into light in the visible wavelength range.

Wavelength conversion is an important technology for generating visible radiation from semiconductor light sources, which are most efficient in the IR or deep blue wavelength range. This up- or down-conversion process can be realized with a waveguide laser that is optically pumped by the semiconductor laser. Such a waveguide laser typically comprises a waveguide having an optical propagation layer between two resonator mirrors which are arranged at the two end faces of the waveguide. The propagation layer consists of a gain medium, also called active medium, that provides an up-conversion or down-conversion of the incident pump light. The propagation layer is surrounded by a material having a lower refractive index than the material of the propagation layer. This surrounding material is also known as cladding layer. In such a waveguide laser, the incident pump light is absorbed by the gain medium and converted into light of a different wavelength, i.e. the lasing wavelength of the waveguide laser.

Waveguide lasers based on up-conversion processes are described, for example, in WO 2005/022708 A1 or in U.S. Pat. No. 5,379,311 A. In both documents the waveguide lasers are end pumped through one of the resonator mirrors by a laser diode or laser diode bar. The input cross-section of the waveguide, i.e. the input cross-section of the propagation layer of the waveguide, is selected to be equal to or greater than the laser diode exit in order to efficiently couple the pump light emitted by the laser diode into the propagation layer of the waveguide laser. The cross-section of this propagation layer remains constant between the two end faces of the waveguide.

The efficiency of any laser is determined by the amount of input power required to reach the laser threshold and by the differential efficiency above the threshold. Laser activity requires a population inversion, i.e. a greater amount of ions has to be in the excited state than in the ground state of the laser transition. The higher the pump energy density, the more easily this condition is reached.

It is an object of the present invention to provide a waveguide laser with an increased efficiency, in particular for visible radiation.

The object is achieved with the optically pumped waveguide laser according to claim 1. Advantageous embodiments of this waveguide laser are the subject matter of the dependent claims or are described in the subsequent part of the description and examples.

The proposed optically pumped waveguide laser comprises a waveguide with an optical propagation layer and two resonator mirrors for forming a resonator cavity. The propagation layer consists of a gain medium at least along one section of the waveguide, said gain medium providing an up-conversion or down-conversion of incident pump light. The first resonator mirror is at least partially transparent to the pump light so as to allow end pumping of the waveguide laser through a first end face of the waveguide. The wave guide of the present invention is characterized in that said propagation layer has a geometrical width or cross-section which is reduced in at least one dimension starting from the first end face towards a second end face in a first section of the waveguide, thereby increasing the energy density of the incident pump light at the end of said first section.

When operating this waveguide laser, the optical pump light, preferably from one or several laser diodes, is coupled through the first end face into the first section of the waveguide. The reduction in geometrical width of the propagation layer in the propagation direction of the incident pump light causes the energy density to be compressed into a smaller volume at the end of the first section. This lowers the laser threshold and increases the efficiency of the arrangement. In the present invention, therefore, the required input power is reduced by the increase in the power density of the pump light inside the waveguide caused by the special geometrical shape of the propagation layer.

In a preferred embodiment of the proposed waveguide laser, one or several laser diodes, preferably a laser diode bar, is or are used as the pumping source for the waveguide laser. For high-power requirements a broad stripe emitter, for example with a thickness of approximately 1 μm and a width of between 50 and 200 μm, may be used. The divergence angle of such a laser diode arrangement in the direction of the small geometrical extent is typically 2×30° to 2×50°. Because of the huge divergence this axis is also called the fast axis. In the direction of the other axis, called slow axis, the divergence is much smaller, for example 2×6°. This angular behavior is conserved for the pump radiation traveling along the waveguide of the present waveguide laser. In the above preferred embodiment, the geometrical width of the propagation layer is reduced only in the direction of the slow axis of the diode pump lasers. This takes into consideration that the waveguide is designed for efficiently coupling in a maximum portion of the pump beam emitted by the laser diode. The materials of the propagation layer and of the surrounding medium of the propagation layer, having an optical refractive index lower than that of the material of the propagation layer, are therefore selected to provide a difference in the refractive indices that is high enough to ensure a proper guidance of the fast axis pump radiation. The present embodiment makes use of the strongly asymmetrical angular distribution of the pump beam. While the guidance of the fast axis radiation is handled by a proper choice of the refractive indices, the slow axis with a far lower divergence is not critical. Therefore the geometrical shape of the propagation layer can be formed in the above sense in the direction of this slow axis as long as the angle of incidence of the slow axis radiation on the boundary of the propagation layer does not exceed the angle of incidence of the fast axis radiation on the boundary layer. This means that the geometrical width of the propagation layer in this direction can be reduced by a factor of 5 to 10.

The reduction of the geometrical width or cross-section of the propagation layer results in a tapered geometrical shape of this propagation layer in the first section of the waveguide. The reduction in width may be a linear reduction or may have any other appropriate shape which results in a concentration of the incident laser pump light into a smaller volume. In one preferred embodiment, this tapered section has a parabolic shape, most preferably the shape of a compound parabolic concentrator (CPC). The reduction of the geometrical cross-section increases the angles of incidence on the boundary of the propagation layer of the pump light traveling along the waveguide. Preferably, the reduction of the geometric cross-section or width is selected such that the quantity angle*dimension is conserved, wherein dimension means the width of the propagation layer. This condition can be fulfilled with the above compound parabolic concentrator. Appropriate design equations for the ideal concentrator form can be found for example in W. T. Welford, et al., “High Collection Nonimaging Optics”, 1989, in particular in chapter 4 or in appendices D and E, incorporated herein by reference.

In the present waveguide laser, the waveguide comprises a first section starting from the first end face and a second section connecting the first section with the second end face of the waveguide. The tapered shape of the propagation layer applies to the first section of the waveguide. Preferably, the propagation layer has a constant cross-section or width throughout the second section. The propagation layer may be formed by the gain medium throughout the entire waveguide, i.e. throughout the first section and the second section. In a preferred embodiment, however, the propagation layer consists of the gain medium in the second section only. This may be realized, for example, by using a suitable host material in the propagation layer, like ZBLAN, which only acts as a gain medium when doped with appropriate elements in a sufficiently high concentration. In this case, this host material is only doped with the appropriate elements in the second region. Examples of such elements are rare earth ions, preferably Er⁺. Er-doped ZBLAN serves as a gain medium for infrared pump light. In the case of ZBLAN as a basic material of the propagation layer, the surrounding material may also consist of ZBLAN with a different stoichiometric composition so as to achieve the required difference in refractive indices.

The waveguide laser and the diode pump laser or laser bar may be placed on the same substrate or on separate substrates. The substrates may be of glass material and/or ceramic material and/or metal, for example copper. Preferably, the diode laser or diode laser bar emits pump light in the infrared or deep blue wavelength region, and the gain medium is selected such that the pump light is converted into light in the visible region, for example blue, green or red radiation. The resonator mirrors of the waveguide are preferably realized in the form of dichroic coatings at the end faces of the waveguide. In one of the embodiments of the waveguide laser it is also possible to arrange the first resonator mirror between the first section and the second section of the waveguide. In this case, in which the first end mirror is preferably formed as a distributed Bragg reflector (DBR), the resonator cavity comprises only the second section of the waveguide. The first resonator mirror is made such that it is highly transparent to the incoming pump light and highly reflective to the generated laser light of the waveguide laser. The second mirror is partly transparent to the laser light in order to be able to couple out a portion of the generated laser light.

In the present description and claims the word “comprising” does not exclude other elements or steps, and “a” or “an” does not exclude a plurality. Any reference signs in the claims shall not be construed as limiting the scope of these claims.

The following description relates to exemplary embodiments of the proposed waveguide laser with reference to the accompanying Figures, without limiting the scope of the invention. In the Figures:

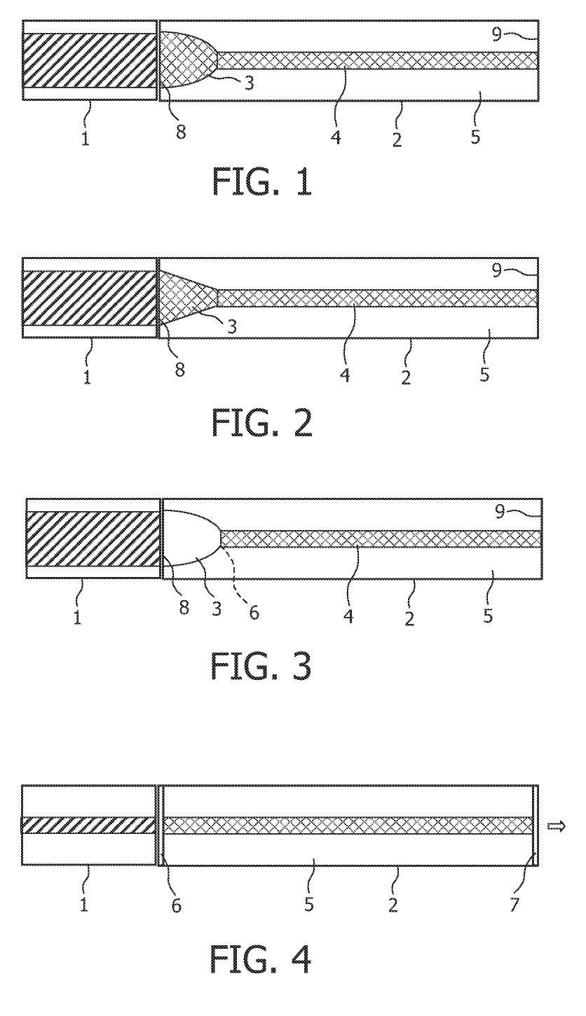

FIG. 1 is a schematic view of a first embodiment of the proposed waveguide laser;

FIG. 2 is a schematic view of a second embodiment of the proposed waveguide laser;

FIG. 3 is a schematic view of a third embodiment of the proposed waveguide laser; and

FIG. 4 is a schematic side elevation of an example of the proposed waveguide laser.

FIG. 1 is a schematic view of a first embodiment of the waveguide laser according to the present invention. This schematic view is perpendicular to the slow axis direction of the diode laser pump light. A schematic view perpendicular to the fast axis direction is shown in FIG. 4. The Figures show a diode laser bar 1 which is arranged with its exit surface close to the first end face 8 of the waveguide laser 2. The waveguide laser 2 comprises a propagation layer 3, 4 surrounded by a cladding material 5 having a lower refractive index than the material of the propagation layer 3, 4.

As can be seen from the Figure, the width of the propagation layer is significantly reduced in a first section of the waveguide laser 2 and then remains constant throughout a second section of this waveguide laser. The tapered portion 3 of the propagation layer has the shape of a compound parabolic concentrator, thus concentrating the pump light incident on the waveguide laser 2 into a smaller volume in the second portion 4 of the propagation layer. Due to this concentration of the pump light of the diode laser bar 1 the energy density in the waveguide increases and the laser threshold is reached more easily. Furthermore, the concentration of the energy emitted by the waveguide laser is higher. The propagation layer starts with a width at the first end face 8 of the waveguide laser 2 which is nearly equal to the emitting width of the diode laser bar 1. On this side of the waveguide laser 2 the first resonator mirror 6 is arranged, which transmits the wavelength of the diode laser bar 1. The propagation layer 3, 4 consists of a gain medium which strongly absorbs the pump wavelength and emits in the visible wavelength range. The first resonator mirror 6 is shown in FIG. 4 together with the second resonator mirror 7 on the second end face 9 of the waveguide laser 2. At this side the visible laser light leaves the waveguide laser 2 in the direction indicated. As can be seen from the comparison of FIGS. 1 and 4, the width of the propagation layer 3, 4 is reduced in the direction of the slow axis of the diode laser light.

FIG. 2 shows a further example, which only differs from the example of FIG. 1 in the shape of the tapered portion 3 of the propagation layer. In the example of FIG. 2 this tapered portion is simply tapered, i.e. the width reduces linearly. In this case the quantity angle*dimension is only approximately conserved throughout the tapered portion 3. The reduction in the lateral dimension realized by this embodiment is somewhat smaller than that of FIG. 1.

FIG. 3 shows a third embodiment of the proposed waveguide laser in which the propagation layer 3, 4 is geometrically identical to the propagation layer 3, 4 of FIG. 1. In the embodiment of FIG. 3, however, only the second portion 4 of the propagation layer provides a gain medium. This is realized by the selection of the proper host material of the propagation layer in both portions, such that only the second portion 4 is sufficiently doped with rare earth ions responsible for the gain of the laser. The advantage of this embodiment is that the relatively large volume in the tapered portion 3 of the propagation layer must not be pumped, i.e. the pump light is not absorbed in this portion, so that the threshold of the waveguide laser is lowered even more. This embodiment requires a special deposition process of the propagation layer which gives different doping levels in different parts of the layer. In this third embodiment, the first resonator mirror 6 may be arranged at the first end face 8 or, as a DBR, between the first portion 3 and the second portion 4 of the propagation layer. The latter is indicated with the dashed line in FIG. 3.

Generally, such a waveguide laser may be manufactured through thin film deposition on a substrate and subsequent structuring of the desired layers of the waveguide in the lateral direction. The special shapes described in this invention can be easily achieved through direct writing or standard lithographic techniques.

### LIST OF REFERENCE SIGNS

1 diode laser bar
2 waveguide laser
3 first portion of propagation layer
4 second portion of propagation layer
5 cladding material
6 first resonator mirror
7 second resonator mirror
8 first end face
9 second end face

1. Optically pumped waveguide laser comprising
a waveguide with an optical propagation layer (3, 4) and two resonator mirrors (6, 7) for forming a resonator cavity,
wherein said propagation layer (3, 4) consists of a gain medium at least along one section of said waveguide, said gain medium providing an up-conversion or down-conversion of incident pump light, and
wherein a first one of said resonator mirrors (6) is at least partially transparent to the pump light so as to allow end-pumping of the waveguide laser through a first end face (8) of said waveguide, characterized in that
a width of said propagation layer (3, 4) is reduced in a first section of the waveguide, starting from said first end face (8) towards a second end face (9).

2. Waveguide laser according to claim 1,
characterized in that the waveguide laser (2) is coupled to a diode laser or diode laser bar (1) for end-pumping the waveguide laser (2) by said diode laser or diode laser bar (1).

3. Waveguide laser according to claim 2,
characterized in that the diode laser or diode laser bar (1) emits pump light in the IR or deep blue wavelength region.

4. Waveguide laser according to claim 2,
characterized in that said width of said propagation layer (3, 4) is reduced in the direction of the slow axis of the pump light.

5. Waveguide laser according to claim 1,
characterized in that said width is reduced in accordance with the geometrical shape of a compound parabolic concentrator (CPC).

6. Waveguide laser according to claim 1,
characterized in that said width is reduced linearly.

7. Waveguide laser according to claim 1,
characterized in that the propagation layer has a constant width or cross-section along a second section of the waveguide, said second section interconnecting the first section and the second end face (9) of the waveguide.

8. Waveguide laser according to claim 7,
characterized in that in the first section the propagation layer (3, 4) consists of a material different from the gain medium, which material does not absorb the pump light or has an absorption coefficient for the pump light lower than that of the gain medium.

9. Waveguide laser according to claim 7,
characterized in that the propagation layer consists of the gain medium throughout the second section.

10. Waveguide laser according to claim 1,
characterized in that the gain medium is Er-doped ZBLAN, and in that the waveguide laser (2) is coupled to a diode laser or diode laser bar (1) for end-pumping of the waveguide laser (2) by said diode laser or diode laser bar (1), which emits pump light in the IR spectral range.
